(19) United States
(12) Patent Application Publication
(10) Pub. No.: US 2026/0164024 A1
(43) Pub. Date: Jun. 11, 2026

(54) SPATIAL GEOMETRIC PARTITIONING MODE IMPROVEMENT FOR VIDEO CODING

(71) Applicant: GUANGDONG OPPO MOBILE TELECOMMUNICATIONS CORP., LTD., Dongguan, Guangdong (CN)

(72) Inventors: Yue YU, Palo Alto, CA (US); Haoping YU, Palo Alto, CA (US); Jonathan GAN, Palo Alto, CA (US)

(73) Assignee: GUANGDONG OPPO MOBILE TELECOMMUNICATIONS CORP., LTD., Dongguan, Guangdong (CN)

(21) Appl. No.: 19/124,254

(22) PCT Filed: Oct. 24, 2023
(86) PCT No.: PCT/US2023/035792

§ 371 Date: Apr. 24, 2025

Related U.S. Application Data
(60) Provisional application No. 63/380,943, filed on Oct. 25, 2022.

(51) Int. Cl. H04N 19/119; H04N 19/105; H04N 19/159; H04N 19/176; H04N 19/196

(52) U.S. Cl. CPC H04N 19/119; H04N 19/105; H04N 19/159; H04N 19/176; H04N 19/196

(57) ABSTRACT

Video encoding/decoding methods and systems for spatial geometric partitioning mode improvement are disclosed. The video encoding/decoding method includes encoding/decoding a candidate-index code into/from a bitstream, wherein the candidate-index code is associated with intra-partition prediction and a template including one or more index-specified reference lines among a plurality of reference lines having a plurality of reconstructed samples spatially neighboring a block associated with a spatial geometric partitioning mode (SGPM).

### CROSS-REFERENCE TO RELATED APPLICATIONS

This application claims the benefit of priority to U.S. Provisional Application No. 63/380,943, entitled “INTRA FUSION AND MULTIPLE REFERENCE LINES FOR SPATIAL GEOMETRIC PARTITIONING MODE,” filed on Oct. 25, 2022, which is hereby incorporated in its entirety by this reference.

### BACKGROUND OF DISCLOSURE

### Field of the Disclosure

The present disclosure relates generally to computer-implemented methods and systems for video processing, and more particularly, to spatial geometric partitioning mode improvement for video coding.

### Description of the Related Art

Video coding has been used in a wide range of applications. For example, regarding a spatial geometric partitioning mode (SGPM), one intra mode is used for each of partitions of an SGPM block, and a fixed reference is used to generate a prediction for a given mode. Thus, there is a further need for video coding performance improvement.

### SUMMARY

An object of the present disclosure is to propose video processing methods and systems to improve video coding performance.

In a first aspect of the present disclosure, a video encoding method includes: encoding a candidate-index code into a bitstream, wherein the candidate-index code is associated with intra-partition prediction and a template including one or more index-specified reference lines among a plurality of reference lines having a plurality of reconstructed samples spatially neighboring a block associated with a spatial geometric partitioning mode (SGPM).

In a second aspect of the present disclosure, a video encoding system includes: a processor; and a memory coupled to the processor, wherein the processor is configured to execute program instructions stored in the memory to perform any one of the above video encoding methods.

In a third aspect of the present disclosure, a non-transitory computer-readable medium having program code stored thereon, the program code executable by a processor to execute any one of the above video encoding methods.

In a fourth aspect of the present disclosure, a video decoding method includes: decoding a candidate-index code from a bitstream, wherein the candidate-index code is associated with intra-partition prediction and a template including one or more index-specified reference lines among a plurality of reference lines having a plurality of reconstructed samples spatially neighboring a block associated with a spatial geometric partitioning mode (SGPM).

In a fifth aspect of the present disclosure, a video decoding system includes: a processor; and a memory coupled to the processor, wherein the processor is configured to execute program instructions stored in the memory to perform any one of the above video decoding methods.

In a sixth aspect of the present disclosure, a non-transitory computer-readable medium having program code stored thereon, the program code executable by a processor to execute any one of the above video decoding methods.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating a picture divided into blocks called coding tree units (CTU) that can be applied to embodiments of the present disclosure.

FIG. 2 is a schematic diagram illustrating a coding tree unit divided into coding units (CUs) that can be applied to embodiments of the present disclosure.

FIG. 3 is a schematic diagram illustrating an example of the current block (such as a CU) and spatially adjacent and non-adjacent reconstructed samples to the current block that can be applied to embodiments of the present disclosure.

FIG. 4 is a schematic diagram illustrating an example of an angular modes and wide-angle intra prediction (WAIP) modes that can be applied to embodiments of the present disclosure.

FIG. 5 is a schematic diagram illustrating an example of a spatial geometric partitioning mode (SGPM) signaling that can be applied to embodiments of the present disclosure.

FIG. 6 is a schematic diagram illustrating an example of a template shape and extended weight that can be applied to embodiments of the present disclosure.

FIG. 7 is a schematic diagram illustrating examples of a geometric partitioning mode (GPM) with inter and intra prediction regarding available intra prediction modes (IPM) candidates and SGPM with intra and intra prediction that can be applied to embodiments of the present disclosure.

FIG. 8 is a schematic diagram illustrating an example of a blending weight that can be applied to embodiments of the present disclosure.

FIG. 9 is a flowchart illustrating a video encoding method according to an embodiment of the present disclosure.

FIG. 10 is a flowchart illustrating a video decoding method according to an embodiment of the present disclosure.

FIG. 11 is a schematic block diagram illustrating an example of a computing device according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Video coding has been used in a wide range of applications. For example, regarding a spatial geometric partitioning mode (SGPM), one intra mode is used for each of partitions of an SGPM block, and a fixed reference is used to generate a prediction for a given mode. Thus, there is a further need for video coding performance improvement.

In the present disclosure, coding refers to encoding and decoding methods and systems.

For example, in the present disclosure, intra fusion and multiple reference lines can be applied for geometric partitioning mode (GPM) for video coding. Methods provided in the present disclosure may be used for future video coding standards. With the implementation of the provided methods, modifications to bitstream structure, syntax, constraints, and mapping for the generation of decoded pictures can be considered for standardizing. The related description is provided as follows.

For example, similar to other video coding schemes like high efficiency video coding (HEVC), versatile video coding (VVC) is a block-based hybrid spatial and temporal predictive coding scheme. During coding, as shown in FIG. 1, an input picture is first divided into square blocks called Coding Tree Units (CTUs) 100, e.g., the CTUs 100 can be blocks of 128×128 pixels or others.

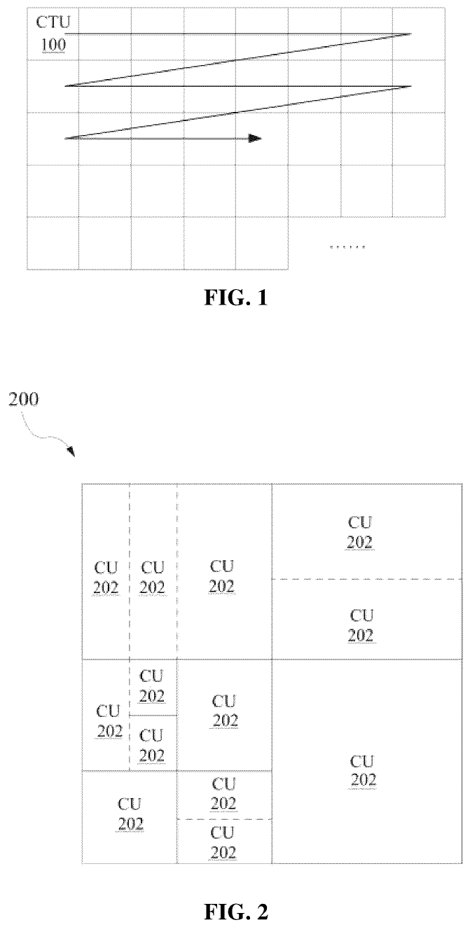

For example, as shown in FIG. 2, in which solid lines indicate quadtree splitting and dashed lines indicate binary tree splitting, is a schematic diagram illustrating a coding tree unit divided into coding units (CUs) that can be applied to embodiments of the present disclosure. In FIG. 2, one CTU 200 in a picture can be partitioned into one or more coding units (CUs) 202, which can be used for prediction and transform. Unlike HEVC, in VVC, the CUs 202 can be rectangular or square and can be coded without further partitioning into prediction units or transform units. In an example, each CU 202 can be as large as its root CTU 200 or be subdivisions of its root CTU 200 as small as 4×4 blocks. In addition, examples of prediction are provided as follows.

### Intra Prediction in VVC and ECM

For example, in intra CUs, spatial neighboring reconstructed samples will be used to predict the current block and the intra mode is signaled once for the entire CU. Intra prediction and transform coding are performed at the CU level and the transform block (TB) level, respectively. Each CU consists of a single TB, except in the cases of intra subpartition (ISP) mode and implicit partitioning prediction. For luma CUs, the maximum side length of a TB is 64 and the minimum side length is 4. In addition, luma TBs are further specified as W×H rectangular blocks of a width W and a height H, wherein W, Hϵ{4, 8, 16, 32, 64}. For chroma CUs, the maximum TB side length is 32, and chroma TBs are rectangular W×H blocks of a width W and a height H, wherein, W, Hϵ{2, 4, 8, 16, 32}, but blocks of shapes 2×H and 4×2 are excluded in order to address memory architecture and throughput requirements.

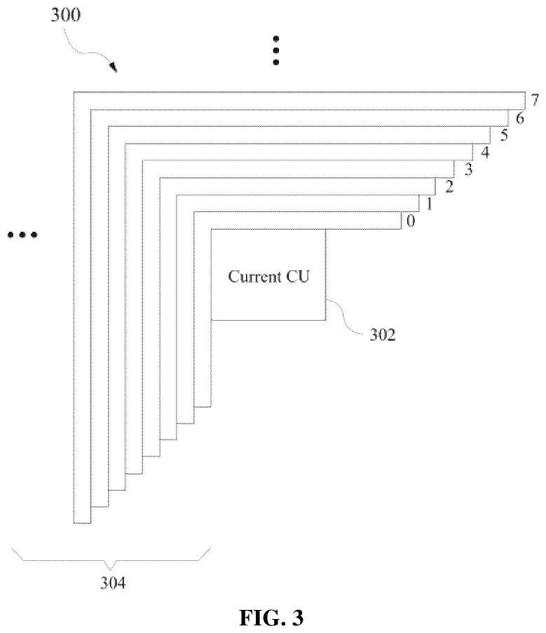

For example, in VVC, the intra prediction samples for the current block are generated using reference samples that are obtained from reconstructed samples of neighboring blocks, such as the left and upper blocks to the current block. As shown in FIG. 3, for a W×H block 300, the reference samples, such as the top and left reconstructed samples, are spatially adjacent to the current block (such as CU) 302, such as consisting of a vertical line of 2−H reconstructed samples to the left of the block and extending downwards and a horizontal line of 2−W reconstructed samples above the current block and extending to the right. This inverted “L” shaped set of samples may be referred to in the present disclosure as a “reference line” 302. One of a plurality of reference lines 302 directly adjacent to the current block 302 is shown as a line with index 0 and others of the plurality of reference lines 302 not adjacent to the current block 302 are shown as lines with indexes 1, 2, 3, 4, 5, 6, 7, . . . .

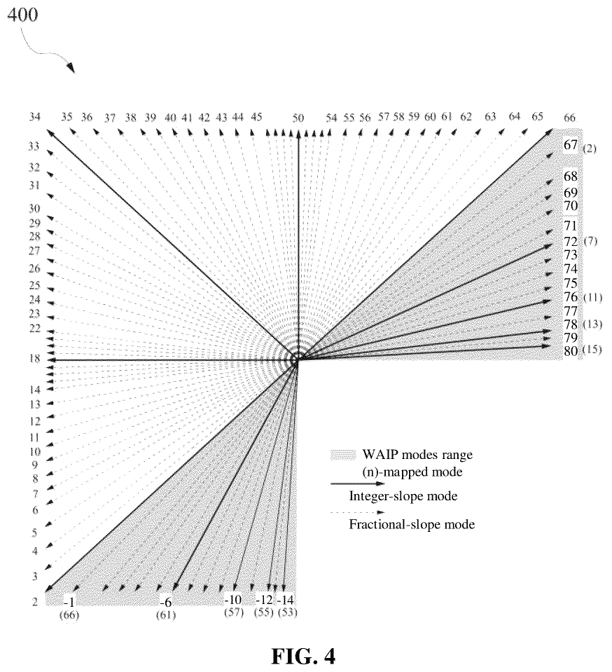

For example, similar to AVC and HEVC, VVC also supports angular intra prediction modes. Angular intra prediction is a directional intra prediction method. In comparison to HEVC, the angular intra prediction of VVC is modified by increasing the prediction accuracy and by an adaptation to the new partitioning framework. The former is realized by enlarging the number of angular prediction directions and by more accurate interpolation filters, while the latter is achieved by introducing wide-angular intra prediction modes. In VVC, the number of directional modes available for a given block is increased to 65 directions from 33 directions for HEVC. A schematic diagram illustrating a graph 400 of different angular modes of VVC is depicted in FIG. 4. The directions having even indexes between 2 and 66 are equivalent to the directions of the angular modes supported in HEVC. For blocks of square shape, an equal number of angular modes is assigned to the top and left side of a block. On the other hand, intra blocks of rectangular shape, which are not present in HEVC, are a central part of VVC's partitioning scheme with additional intra prediction directions assigned to the longer side of a block. The additional modes allocated along a longer side are called wide-angle intra prediction (WAIP) modes, since they correspond to prediction directions with angles greater than 45 degrees (°) relative to the horizontal or vertical mode. A WAIP mode for a given mode index is defined by mapping the original directional mode to a mode that has the opposite direction with an index offset equal to one, as shown in FIG. 4. For a given rectangular block, the aspect ratio, i.e., the ratio of width to height, is used to determine which angular modes are to be replaced by the corresponding wide-angular modes.

In VVC, both square and rectangular blocks can use one non-adjacent reference line called a multiple reference line (MRL). For example, the prediction is formed by line two or line three to the left and above a block instead of always using line one.

For example, as shown in FIG. 3, in addition to the directly adjacent line (e.g., line 0) of neighboring samples, one of the two non-adjacent reference lines (e.g., lines 1 and 2) can include the input for intra prediction in VVC. For enhanced compression model (ECM), more non-adjacent reference lines may be used. The use of adjacent and non-adjacent reference samples is referred to as multiple reference line (MRL) prediction.

For example, the intra modes that can be used for MRL are a DC mode and angular prediction modes. In another aspect, for a given block, not all of these modes can be combined with MRL. The MRL mode is always coupled with a most probable mode (MPM) in VVC. This coupling means that if non-adjacent reference lines are used, the intra prediction mode is one of MPMs. Such a design of an MPM-based MRL prediction mode is motivated by the observation that non-adjacent reference lines are mainly beneficial for texture patterns with sharp and strongly directed edges. In these cases, MPMs are much more frequently selected since there is typically a strong correlation between the texture patterns of the neighboring and the current blocks. On the other hand, choosing a non-MPM for intra prediction is an indication that edges are not consistently distributed in neighboring blocks, and thus the MRL prediction mode is expected to be less useful in this case.

In addition, it has been observed that MRL does not provide additional coding gain when the intra prediction mode is a planar mode, since this mode is typically used for smooth areas. Consequently, MRL excludes the planar mode, which is always one of the MPMs. The angular or DC prediction process in MRL is very similar to the case of a directly adjacent reference line. In another aspect, for angular modes with a non-integer slope, a DCT-based interpolation filter (DCTIF) is always used. This design choice is both evidenced by experimental results and aligned with the empirical observation that MRL is mostly beneficial for sharp and strongly directed edges, wherein the DCTIF is more appropriate since it retains more high frequencies than a smoothing interpolation filter (SIF).

In an example, from a hardware design perspective, applying multiple reference lines as provided in a method requires an extra cost of line buffers that are used for holding the additional reference lines. In typical hardware designs, line buffers are a part of an on-chip memory architecture for image and video coding and it is of great importance to minimize their on-chip area. To address this issue, MRL is disabled and not signaled for the coding units that are attached to the top boundary of the CTU. In this way, the extra buffers for holding non-adjacent reference lines are bounded by 128, which is a width of the largest unit size.

### Intra Fusion

For example, an intra prediction fusion method is provided to improve the accuracy of intra prediction. More specifically, if the current block is a luma block, and it is coded with a non-integer slope angular mode and not as the ISP mode, and the block size (width*height) is greater than 16, two prediction blocks generated from two different reference lines will be “fused”, wherein a fusion prediction is a weighted summation of the two prediction blocks. Specifically, a first reference line at an index i (lineᵢ) is specified with a method (such as provided as above) of signaling in a bitstream, and the prediction block generated from this reference line using the selected intra prediction mode is denoted as p(lineᵢ), wherein p(⋅) represents the operation of generating a prediction block from a reference line with a given intra prediction mode. In the intra prediction fusion method, the reference line lineᵢ₊₁ is implicitly selected as the second reference line. That is, the second reference line is one index position further away from the current block relative to the first reference line. Similarly, the prediction block generated from the second reference line using the same given intra prediction mode is denoted as p(lineᵢ₊₁). The weighted sum of the two prediction blocks is obtained as follows and serves as the predictor for the current block.

$${p}_{fusion} = {w}_{0} * p ( {line}_{i} ) + {w}_{1} * p ( {line}_{i + 1} ) ,$$

wherein p_{fusion} represents the fusion prediction, w₀ and w₁ are two weighting factors and they are set as ¾ and ¼ in the experiment, respectively.

### Spatial Geometric Partitioning Mode

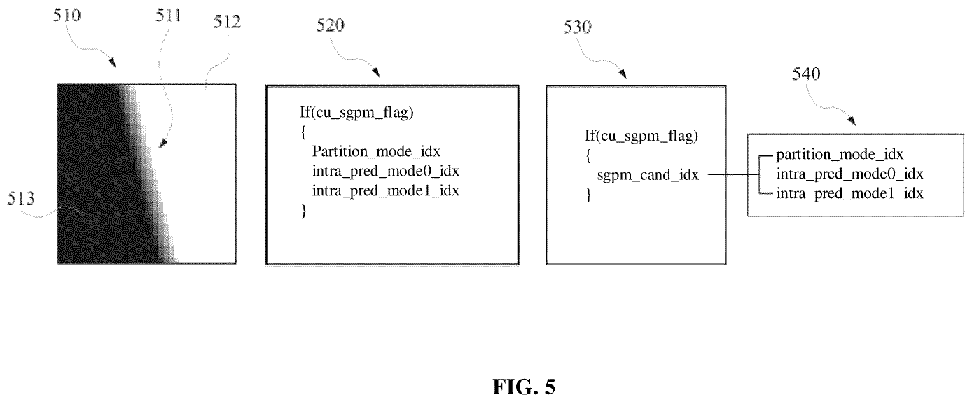

For example, a spatial geometric partitioning mode (SGPM) is provided which allows the partitioning of a CU into two parts which may use different intra prediction modes. The new mode is similar in concept to the geometric partitioning mode (GPM) which applies to inter prediction in VVC. In another aspect, SGPM uses a different signalling mechanism due to a large number of combinations of partitions and intra prediction modes that are possible. To express the necessary partition and prediction information more efficiently in a bitstream, a candidate list is employed and only a candidate index is signaled in the bitstream. Each candidate in the list can derive a combination of one partition mode and two intra prediction modes, as shown in FIG. 5.

For example, as shown in FIG. 5, a CU 510 can be partitioned, using a partition mode (shown as 511, such as “Partition_mode”), into two parts (shown as parts 512 and 513) with different intra prediction modes (such as “Intra_pred_mode0” and “Intra_pred_mode1”), which can be expressed as a syntax structure 520 having a partition mode index (such as “partition_mode_idx”) and two intra prediction modes (such as “intra_pred_mode0_idx” and “intra_pred_mode0_idx”). In another aspect, another syntax structure 530 is further provided to indicate a combination 540 of one candidate index (such as “sgpm_cand_idx”) indicating a combination of one partition mode (such as “partition_mode_idx”) and two intra prediction modes (such as “intra_pred_mode0_idx” and “intra_pred_mode0_idx”).

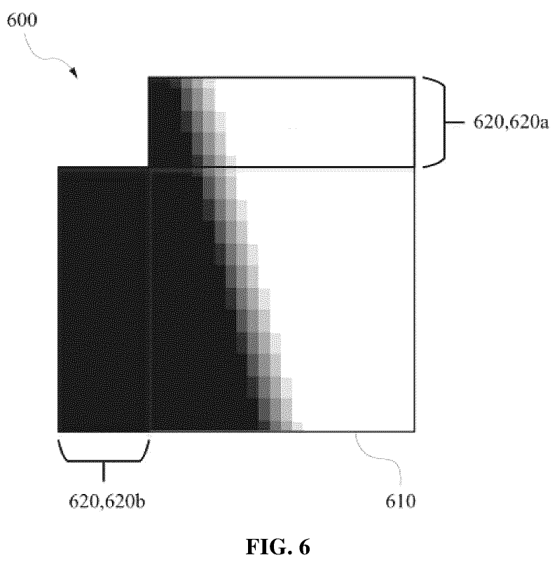

For example, a template is used to generate one candidate list. In one example, an illustration 600 having a CU 610 and one template 620 (shown as two template components 620a and 620b) is illustrated in FIG. 6, in which a width of the template 620 is set to 4. In another aspect, for a SGPM adopted to ECM, the template width is set to 1. For each possible combination of one partition mode and two intra prediction modes, a prediction is generated for the template with the partitioning weight extended to the template, as shown in FIG. 6. These combinations are ranked in ascending order of their sum of absolute transformed difference (SATD) costs between the prediction and reconstruction of the template. For example, the size of the candidate list is set equal to 16, and these candidates are regarded as the most probable SGPM combinations of the current block. Both the encoder and decoder construct the same candidate list using the template. To reduce the complexity of building the candidate list, both the number of possible partition modes and the number of possible intra prediction modes (IPM) are limited. For example, the number of possible partition modes in the current version of SGPM adopted to ECM can be restricted to a pre-defined set of 26 partitions, which cover a variety of partition directions and locations. In an example, a variety of templates associated with 26 partitions can be tried to find one of 26 partitions with the lowest cost.

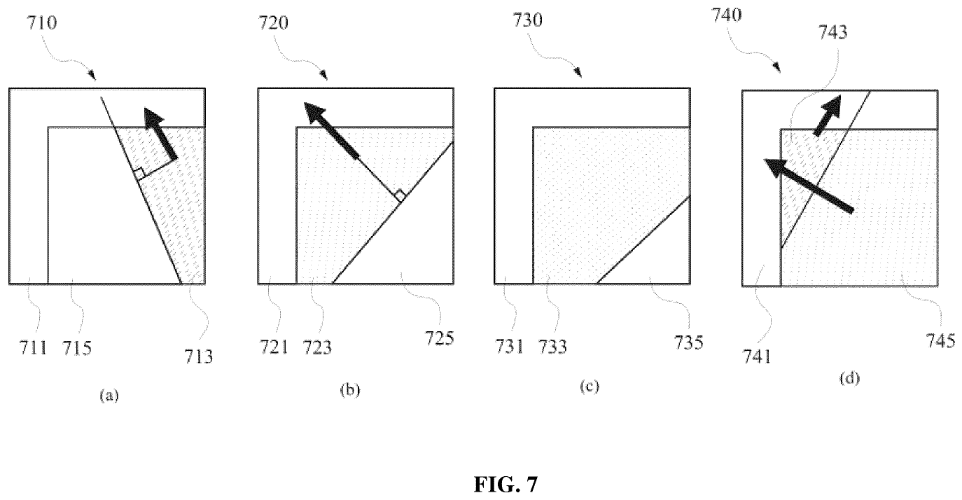

For example, two IPM candidate lists corresponding to two SGPM partitions are each constructed by adding available IPM candidates, and then pruning if needed down to a pre-defined limit of three candidates. Some IPM candidates are inherited from an intra-inter GPM mode already adopted into ECM. As shown in FIG. 7, GPM with inter and intra prediction is illustrated, in which the inter angular mode parallel to the GPM partitioning boundary (such as a parallel mode), the inter angular mode perpendicular to the GPM partitioning boundary (such as a perpendicular mode), and the inter prediction planar mode, as shown as (a) to (c) in FIG. 7, may be added as available IPM candidates for SGPM, respectively; and a SGPM with intra and intra prediction, shown as (d) in FIG. 7, is illustrated. For example, as shown in FIG. 7, an available IPM candidate 710 includes a region 711 having reconstructed samples, a region 713 for intra prediction, and a region 715 for inter prediction; an available IPM candidate 720 includes a region 721 having reconstructed samples, a region 723 for intra prediction, and a region 725 for inter prediction; an available IPM candidate 730 includes a region 731 having reconstructed samples, a region 733 for intra prediction, and a region 735 for inter prediction; an SGPM candidate 740 includes a region 741 having reconstructed samples, a region 743 for intra prediction, and a region 745 for inter prediction.

In addition, template-based intra mode derivation (TIMD) may be used to derive intra prediction modes that are available IPM candidates for SGPM. For example, only neighbors of horizontal and vertical orientations (such as using the top or left templates) are used to derive TIMD intra prediction modes for forming the IPM of SGPM.

For example, SGPM is implicitly disabled for some CU block sizes. A range of block sizes for which SGPM may be used (i.e., a CU level flag may be signalled to indicate if SGPM is used or not) is originally inherited from the intra-inter GPM mode. In the SGPM adopted to ECM, the range of block sizes is further extended to smaller blocks of 4×8, 8×4, 4×16, and 16×4 dimension. In summary, the block sizes for which SGPM may be used are one of size restrictions, such as 4<=width<=64, 4<=height<=64, width<height*8, height<width*8, or width*height>=32, wherein “width” and “height” represents the width and height of the current block.

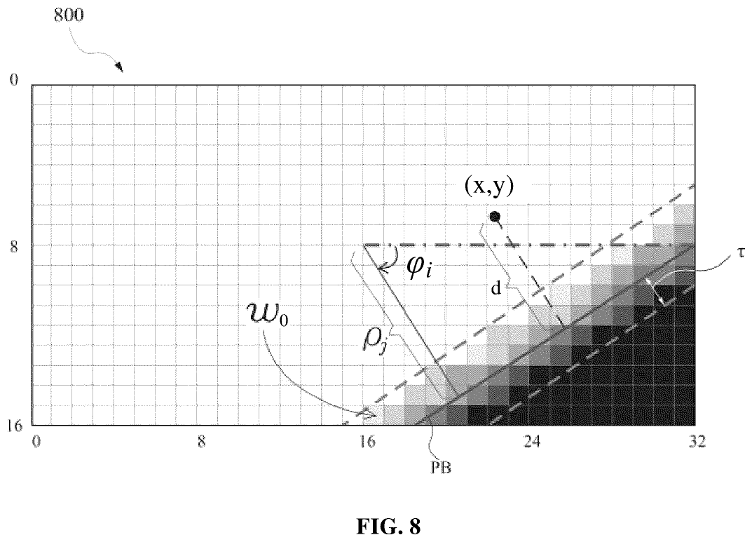

For example, as shown in FIG. 8, an adaptive SGPM blending scheme 800 may be used to have a better prediction for those pixels which sit in a boundary PB (such as a GPM partitioning boundary) between two prediction parts, wherein a weighted average of the two prediction parts is used in a transition region around the SGPM partition. The width of the transition region is referred to as a blending width. The blending width is adaptively determined depending on the block size. No signalling is needed for adaptive blending. In addition, as shown in FIG. 8, (x, y) are coordinates of a pixel in a normal direction perpendicular to the boundary PB; d is a distance between the coordinates of the pixel and the boundary PB; an angle φᵢ and a distance ρⱼ are formed between the normal direction and a horizontal direction; ω₀ indicates a region regarding the boundary PB, e.g., ω₀ indicates the transition region. Further, as shown in FIG. 8, let the blending width as specified for a GPM tool in VVC and ECM be T. Then the adaptive SGPM blending width may be determined depending on the CU block width and height as follows. If min(width, height)==4, (½)τ is selected; else if min(width, height)==8, τ is selected; else if min(width, height)==16, 2τ is selected; else if min(width, height)==32, 4τ is selected; else, 8τ is selected.

It should be noted that, in the related art, one intra mode is used for each partition of an SGPM block, and a single fixed reference (such as a reference line 0) is used to generate a prediction for a given intra mode. In the present disclosure, the coding performance could be further improved to allow SGPM block to use intra fusion and MRL. Examples are provided as follows.

In the present disclosure, a video encoding method is provided for spatial geometric partitioning mode coding, examples are provided as follows.

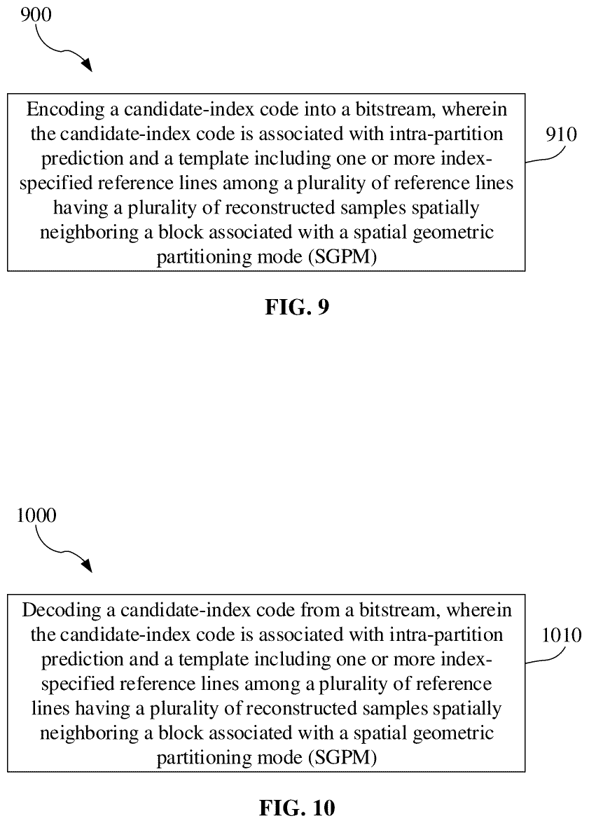

For example, a flowchart illustrating a video encoding method according to an embodiment of the present disclosure is shown in FIG. 9, in which an example of a video encoding method 900 is provided. The video encoding method 900 includes: a box 910, encoding a candidate-index code into a bitstream, wherein the candidate-index code is associated with intra-partition prediction and a template including one or more index-specified reference lines among a plurality of reference lines having a plurality of reconstructed samples spatially neighboring a block associated with a spatial geometric partitioning mode (SGPM). For example, one index-specified reference line may be specified with an index to indicate which reference line is used for one or both partitions of an SGPM rather than a fixed reference line.

Correspondingly, a video decoding method is provided for spatial geometric partitioning mode coding, examples are provided as follows.

For example, a flowchart illustrating a video decoding method according to an embodiment of the present disclosure is shown in FIG. 10, in which an example of a video decoding method 1000 is provided. The video decoding method 1000 includes: a box 1010, decoding a candidate-index code from a bitstream, wherein the candidate-index code is associated with intra-partition prediction and a template including one or more index-specified reference lines among a plurality of reference lines having a plurality of reconstructed samples spatially neighboring a block associated with a spatial geometric partitioning mode (SGPM).

In some embodiments, as illustrated by the box 910 shown in FIG. 9 and the box 1010 shown in FIG. 10, the candidate-index code is associated with a combination of a partition-mode index, a first-intra-prediction-mode index, and a second-intra-prediction-mode index, the first-intra-prediction-mode index indicates a first intra-prediction mode for a first partition of the block based on a single reference line, such as the single reference line with an index indicated by an encoder/decoder rather than a fixed index, and the second-intra-prediction-mode index indicates a second intra-prediction mode for a second partition of the block based on the single reference line. The example is provided as follows.

### Example 1

The present disclosure provides that MRL may be applied to an SGPM block. As one example, one index, e.g., i, may be specified to indicate which reference line is used for both partitions of an SGPM block instead of always using line 0. As another example, two line indexes, i and j may be specified for two partitions of an SGPM block to indicate which reference line is used for each partition of the SGPM block, respectively.

Specifically, there are two partitions for an SGPM block. The first partition may use the first intra mode which is represented by a valid intra mode index, intra_mode1. The second partition may use the second intra mode which is represented by a valid intra mode index, intra_mode2. For the given reference line and intra prediction mode for a partition of an SGPM block, the intra prediction can be generated and is called intra partition prediction.

In some embodiments, as illustrated by box 910 shown in FIG. 9 and box 1010 shown in FIG. 10, the candidate-index code is associated with a combination of a partition-mode index, a first-intra-prediction-mode index, and a second-intra-prediction-mode index, the first-intra-prediction-mode index indicates a first intra-prediction mode for a first partition of the block based on a single reference line indexed by a line index signaled in the bitstream, and the second-intra-prediction-mode index indicates a second intra-prediction mode for a second partition of the block based on the single reference line. An example is provided below.

For the first example, reference line line_i and intra prediction mode intra_mode1 will be used to generate intra partition prediction for the first partition of an SGPM block. Reference line line_i and intra prediction mode intra_mode2 will be used to generate intra partition prediction for the second partition of an SGPM block.

The reference line index i may be signalled by the existing syntax signalling syntax of MRL. Alternatively, the SGPM candidate list construction process may be extended to all available combinations of the partitioning mode, the two IPM modes of the corresponding partitions, and the reference line index.

In some embodiments, as illustrated by box 910 shown in FIG. 9 and box 1010 shown in FIG. 10, the candidate-index code is associated with a combination of a partition-mode index, a first-intra-prediction-mode index, and a second-intra-prediction-mode index, the first-intra-prediction-mode index indicates a first intra-prediction mode for a first partition of the block based on a first reference line indexed by a first line index signaled in the bitstream, and the second-intra-prediction-mode index indicates a second intra-prediction mode for a second partition of the block based on a second reference line indexed by a second line index signaled in the bitstream. Another example is provided below.

For the second example, a reference line line_i and intra prediction mode intra_mode1 will be used to generate intra partition prediction for the first partition of an SGPM block; a reference line line_j and intra prediction mode intra_mode2 will be used to generate intra partition prediction for the second partition of an SGPM block. The reference line indexes i and j may be signalled by the existing signalling syntax of MRL. Alternatively, the SGPM candidate list construction may be extended to all available combinations of the partitioning mode, the two IPM modes of the corresponding partitions, and the two reference line indexes of the corresponding partitions.

### Example 2

The present disclosure further provides that the intra fusion may be used for an SGPM block. More specifically, there are two partitions for an SGPM block.

In some embodiments, as illustrated by box 910 shown in FIG. 9 and box 1010 shown in FIG. 10, the candidate-index code is associated with a combination of a partition-mode index, a first-intra-prediction-mode index, and a second-intra-prediction-mode index, the first-intra-prediction-mode index and the second-intra-prediction-mode index indicate two given intra prediction modes for two partitions of the block associated with fused intra partition prediction being expressed as follows: p_{fusion_partition}=w₀*p_partition(lineᵢ)+w₁*p_partition(lineᵢ₊₁), wherein p_{fusion_partition} represents the fused intra partition prediction for each of the two partitions, w₀ and w₁ are two weighting factors summarized as equal to one, p_partition(⋅) represents an operation function for generating an intra partition prediction based on a given reference line of the plurality of reference lines with one of the two given intra prediction modes, and lineᵢ and lineᵢ₊₁ are two given reference lines of the plurality of reference lines indexed by two indexes i and i+1, e.g., the index i may be coded in the bitstream or inferred as a default value, e.g. 0 without coding.

For example, two reference lines, e.g., line 0 and line 1 as shown in FIG. 3, may be used to generate two corresponding intra partition predictions for each partition with a given intra prediction mode. Once two intra partition predictions are generated for one partition, the fusion prediction for the current partition could be obtained by using the following formula, p_{fusion_partition}=w₀*p_partition(lineᵢ)+w₁*p_partition(lineᵢ₊₁), wherein p_{fusion_partition} represents the fused intra partition prediction for the current partition, w₀ and w₁ are two weighting factors and they may be set as ¾ and ¼. A first reference line at index i (lineᵢ) is specified with the above method of signaling in the bitstream, and the intra partition prediction generated from this reference line using the selected intra prediction mode is denoted as p_partition(lineᵢ), wherein p_partition(⋅) represents the operation of generating an intra partition prediction from a given reference line with a given intra prediction mode. The above process could be called SGPM intra prediction fusion. This SGPM intra prediction fusion may apply to all allowed intra modes, restricted to all allowed angular intra modes, or some angular intra modes with some restrictions, e.g., not integer slope angular intra modes. SGPM intra prediction fusion may also be restricted to certain CU block sizes.

In some embodiments, as illustrated by box 910 shown in FIG. 9 and box 1010 shown in FIG. 10, the index i is predetermined to be zero or is signaled in the bitstream.

As one example, the reference line lineᵢ may not be specified and the default reference line is 0. In other words, SGPM intra prediction fusion will always fuse two intra partition predictions based on line 0 and line 1.

In some embodiments, as illustrated by box 910 shown in FIG. 9 and box 1010 shown in FIG. 10, the index i and the candidate-index code are signaled jointly or separately in one or more syntax structures of the bitstream. An example is provided as follows.

In another example, enabling MRL and intra fusion methods for an SGPM block could be signaled jointly or separately at different levels of syntax structures, e.g., a sequence parameter set (SPS), a picture header (PH), a picture parameter set (PPS), and a slice header (SH).

### Example 3

This disclosure proposes to use two sets of the combination of one partitioning mode and two intra prediction modes (e.g., there are totally two partitioning mode and four intra prediction modes) to generate an SGPM prediction fusion, wherein each combination set produces an individual CU/block prediction by the way of the existing SGPM method, and the final SGPM prediction fusion is a weighted summation of the two individual predictions.

In some embodiments, as illustrated by box 910 shown in FIG. 9 and box 1010 shown in FIG. 10, the candidate-index code is associated with two sets of a combination of a partition-mode index and two intra-prediction-mode indexes associated with an SGPM prediction fusion for the block, the SGPM prediction fusion is expressed into a weighted summation of the two set with two weighting parameters that are two different fixed numbers summarized as equal to one. An example is provided as follows.

For example, the weighting parameters, for example, can be fixed numbers such as ½ and ½, or ¼ and ¾. Alternatively, other fixed numbers can be used in a particular scenario.

In some embodiments, as illustrated by box 910 shown in FIG. 9 and box 1010 shown in FIG. 10, each of the two weighting parameters is expressed as a function of a distance between a pixel within the block and a reference pixel within the template. An example is provided as follows.

For example, the weighting parameters can also be a function of the relative distance between the current pixel and the reference pixel.

In some embodiments, as illustrated by box 910 shown in FIG. 9 and box 1010 shown in FIG. 10, the candidate-index code is associated with two combination-candidate-index components indicating the two sets of the combination of the partition-mode index and the two intra-prediction-mode indexes. An example is provided as follows.

As one example, the two combination sets can be signaled in the bitstream by two combination candidate indexes, which can be determined by an encoder RDO process.

In some embodiments, as illustrated by box 910 shown in FIG. 9 and box 1010 shown in FIG. 10, the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is set to the partition-mode index associated with the single combination-candidate-index component, and the two specific intra-prediction-mode indexes are two intra-prediction-mode indexes adjacent to the two intra-prediction-mode indexes associated with the single combination-candidate-index component as one candidate index in a list. An example is provided as follows.

As another example, only one candidate index is sent in the bitstream, by the current SGPM method, to signal the first combination set. Then, the second combination set uses the same partitioning mode derived from the signaled candidate index and two intra modes that are adjacent to the intra modes derived from the signaled candidate index (e.g., two intra modes derived from the signaled candidate index +1 or −1).

In some embodiments, as illustrated by box 910 shown in FIG. 9 and box 1010 shown in FIG. 10, the two specific intra-prediction-mode indexes are distanced from the two intra-prediction-mode indexes associated with the single combination-candidate-index component by a fixed offset. An example is provided as follows.

For example, these two adjacent intra modes can be either in or outside of the candidate list and can be on the either side by adding a fixed offset, as long as both encoder and decoder are following the same predefined rules.

In some embodiments, as illustrated by box 910 shown in FIG. 9 and box 1010 shown in FIG. 10, the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is set to the partition-mode index associated with the single combination-candidate-index component, and the two specific intra-prediction-mode indexes are set to two intra-prediction-mode indexes associated with another candidate index in a list whose partition-mode index is equal to the partition-mode index associated with the single combination-candidate-index component. An example is provided as follows.

As another example, the two intra modes can be set to the intra modes of any candidate in the list whose partitioning mode is the same as the one associated with the combination index signaled in the bitstream.

In some embodiments, as illustrated by box 910 shown in FIG. 9 and box 1010 shown in FIG. 10, in response to determining there is more than one candidate index in the list whose partition-mode index is equal to the partition-mode index associated with the single combination-candidate-index component, the two specific intra-prediction-mode indexes are set to two intra-prediction-mode indexes associated with one candidate index in the list with the smallest sum of absolute transformed difference (SATD) cost between a prediction and a reconstruction of the template. An example is provided as follows.

For example, if there is more than one candidate with the same partitioning mode, the candidate with the smallest SATD cost will contribute the two intra modes to the second combination set.

In some embodiments, as illustrated by box 910 shown in FIG. 9 and box 1010 shown in FIG. 10, the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is one partition-mode index adjacent to the partition-mode index associated with the single combination-candidate-index component as one candidate index in a list, and the two specific intra-prediction-mode indexes are set to the two intra-prediction-mode indexes associated with the single combination-candidate-index component. An example is provided as follows.

As another example, only one candidate index is sent in the bitstream, by the current SGPM method, to signal the first combination set. Then, the second combination set uses the same intra modes derived from the signaled candidate index and the partitioning mode that is adjacent to the partitioning mode derived from the signaled candidate index (e.g., the partitioning mode derived from the signaled candidate index +1 or −1).

In some embodiments, as illustrated by box 910 shown in FIG. 9 and box 1010 shown in FIG. 10, the specific partition-mode index is distanced from the partition-mode index associated with the single combination-candidate-index component by a fixed offset. An example is provided as follows.

For example, these two adjacent partition modes can be either in or outside of the candidate list and can be on the either side by adding a fixed offset, as long as both encoder and decoder are following the same predefined rules.

In some embodiments, as illustrated by box 910 shown in FIG. 9 and box 1010 shown in FIG. 10, the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is set to one partition-mode index associated with another candidate index in a list whose two intra-prediction-mode indexes are equal to the two intra-prediction-mode indexes associated with the single combination-candidate-index component, and two specific intra-prediction-mode indexes are set to the two intra-prediction-mode indexes associated with the single combination-candidate-index component. An example is provided as follows.

As another example, the partitioning mode can be set to the partitioning mode of any candidate in the list whose intra modes are the same as those associated with the combination index signaled in the bitstream.

In some embodiments, as illustrated by box 910 shown in FIG. 9 and box 1010 shown in FIG. 10, in response to determining there is more than one candidate index in the list whose two intra-prediction-mode indexes are equal to the partition-mode index associated with the single combination-candidate-index component, the specific partition-mode index is set to one partition-mode index associated with one candidate index in the list with the smallest sum of absolute transformed difference (SATD) cost between a prediction and a reconstruction of the template. An example is provided as follows.

For example, if there is more than one candidate with the same prediction modes, the candidate with the smallest SATD cost will contribute the partitioning mode to the second combination set.

In some embodiments, as illustrated by box 910 shown in FIG. 9 and box 1010 shown in FIG. 10, the candidate-index code is associated with a single combination-candidate-index component indicating a first set of the two sets of the combination of the partition-mode index and the two intra-prediction-mode indexes, and a second set of the two sets of the combination of the partition-mode index and the two intra-prediction-mode indexes is a combination of a specific partition-mode index and two specific intra-prediction-mode indexes associated with one candidate index in a list with the smallest sum of absolute transformed difference (SATD) cost between a prediction and a reconstruction of the template. An example is provided as follows.

As another example, only one candidate index is sent in the bitstream, by the current SGPM method, to signal the first combination set. Then the second combination set always uses the candidate with the smallest SATD in the list.

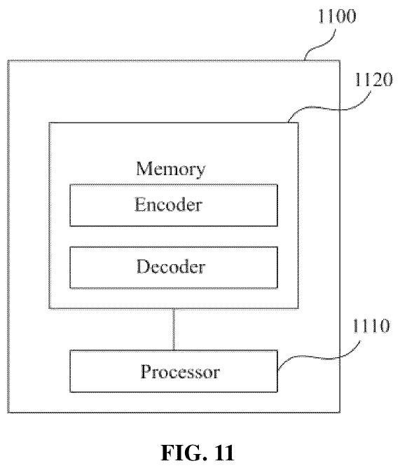

In addition, any suitable computing system can be used for performing the operations for video encoding like a video encoder or video decoding like a video decoder described herein. For example, FIG. 11 depicts an example of a computing device 1100 having a processor 1110 coupled to a memory 1120 that can implement methods such as video encoding methods or video decoding methods herein.

In some embodiments, the computing device includes a processor that is coupled to a memory and is configured to execute program instructions stored in the memory to perform the operations for implementing a video encoding method associated with an encoder or a video decoding method associated with a decoder.

For example, the processor may include a microprocessor, an application-specific integrated circuit (“ASIC”), a state machine, or other processing device, e.g., the processor includes one or more processing units. Such a processor can include or may be in communication with a computer-readable medium storing instructions that, when executed by the processor, cause the processor to perform the operations described herein. The memory includes any suitable non-transitory computer-readable medium.

For example, the computer-readable medium includes any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer programming language, including, for example, C, C++, C#, Visual Basic, Java, Python, Perl, JavaScript, and ActionScript.

In some embodiments, the present disclosure provides that a video encoding system includes: a processor; and a memory coupled to the processor, wherein the processor is configured to execute program instructions stored in the memory to perform any one of the above video encoding methods.

In some embodiments, the present disclosure provides a non-transitory computer-readable medium having program code stored thereon, the program code executable by a processor to execute any one of the above video encoding methods.

In some embodiments, the present disclosure provides that a video decoding system includes: a processor; and a memory coupled to the processor, wherein the processor is configured to execute program instructions stored in the memory to perform any one of the above video decoding methods.

In some embodiments, the present disclosure provides a non-transitory computer-readable medium having program code stored thereon, the program code executable by a processor to execute any one of the above video decoding methods.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan provided by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A video encoding method, comprising:
encoding a candidate-index code into a bitstream, wherein the candidate-index code is associated with intra-partition prediction and a template comprising one or more index-specified reference lines among a plurality of reference lines having a plurality of reconstructed samples spatially neighboring a block associated with a spatial geometric partitioning mode (SGPM).

2-20. (canceled)

21. A video decoding method, comprising:
decoding a candidate-index code from a bitstream, wherein the candidate-index code is associated with intra-partition prediction and a template comprising one or more index-specified reference lines among a plurality of reference lines having a plurality of reconstructed samples spatially neighboring a block associated with a spatial geometric partitioning mode (SGPM).

22. The method of claim 21, wherein the candidate-index code is associated with a combination of a partition-mode index, a first-intra-prediction-mode index, and a second-intra-prediction-mode index, the first-intra-prediction-mode index indicates a first intra-prediction mode for a first partition of the block based on a single reference line indexed by a line index signaled in the bitstream, and the second-intra-prediction-mode index indicates a second intra-prediction mode for a second partition of the block based on the single reference line.

23. The method of claim 21, wherein the candidate-index code is associated with a combination of a partition-mode index, a first-intra-prediction-mode index, and a second-intra-prediction-mode index, the first-intra-prediction-mode index indicates a first intra-prediction mode for a first partition of the block based on a first reference line indexed by a first line index signaled in the bitstream, and the second-intra-prediction-mode index indicates a second intra-prediction mode for a second partition of the block based on a second reference line indexed by a second line index signaled in the bitstream.

24. The method of claim 21, wherein the candidate-index code is associated with a combination of a partition-mode index, a first-intra-prediction-mode index, and a second-intra-prediction-mode index, the first-intra-prediction-mode index and the second-intra-prediction-mode index indicate two given intra prediction modes for two partitions of the block associated with fused intra partition prediction being expressed as follows:
$${p}_{fusion\_partition} = {w}_{0} * p\_partition ( {line}_{i} ) + {w}_{1} * p\_partition ( {line}_{i + 1} ) ,$$
wherein p_{fusion_partition} represents the fused intra partition prediction for each of the two partitions, w₀ and w₁ are two weighting factors summarized as equal to one, p_partition(⋅) represents an operation function for generating an intra partition prediction based on a given reference line of the plurality of reference lines with one of the two given intra prediction modes, and line₁ and lineᵢ₊₁ are two given reference lines of the plurality of reference lines indexed by two indexes i and i+1.

25. The method of claim 24, wherein the index i is predetermined to be zero or is signaled in the bitstream.

26. The method of claim 25, wherein the index i and the candidate-index code are signaled jointly or separately in one or more syntax structures of the bitstream.

27. The method of claim 21, wherein the candidate-index code is associated with two sets of a combination of a partition-mode index and two intra-prediction-mode indexes associated with an SGPM prediction fusion for the block, the SGPM prediction fusion is expressed into a weighted summation of the two set with two weighting parameters that are two different fixed numbers summarized as equal to one.

28. The method of claim 27, wherein each of the two weighting parameters is expressed as a function of a distance between a pixel within the block and a reference pixel within the template.

29. The method of claim 27, wherein the candidate-index code is associated with two combination-candidate-index components indicating the two sets of the combination of the partition-mode index and the two intra-prediction-mode indexes.

30. The method of claim 27, wherein the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is set to the partition-mode index associated with the single combination-candidate-index component, and the two specific intra-prediction-mode indexes are two intra-prediction-mode indexes adjacent to the two intra-prediction-mode indexes associated with the single combination-candidate-index component as one candidate index in a list.

31. The method of claim 30, wherein the two specific intra-prediction-mode indexes are distanced from the two intra-prediction-mode indexes associated with the single combination-candidate-index component by a fixed offset.

32. The method of claim 27, wherein the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is set to the partition-mode index associated with the single combination-candidate-index component, and the two specific intra-prediction-mode indexes are set to two intra-prediction-mode indexes associated with another candidate index in a list whose partition-mode index is equal to the partition-mode index associated with the single combination-candidate-index component.

33. The method of claim 32, wherein in response to determining there is more than one candidate index in the list whose partition-mode index is equal to the partition-mode index associated with the single combination-candidate-index component, the two specific intra-prediction-mode indexes are set to two intra-prediction-mode indexes associated with one candidate index in the list with the smallest sum of absolute transformed difference (SATD) cost between a prediction and a reconstruction of the template.

34. The method of claim 27, wherein the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is one partition-mode index adjacent to the partition-mode index associated with the single combination-candidate-index component as one candidate index in a list, and the two specific intra-prediction-mode indexes are set to the two intra-prediction-mode indexes associated with the single combination-candidate-index component.

35. The method of claim 34, wherein the specific partition-mode index is distanced from the partition-mode index associated with the single combination-candidate-index component by a fixed offset.

36. The method of claim 27, wherein the candidate-index code is associated with a single combination-candidate-index component indicating a first set of the two sets of the combination of the partition-mode index and the two intra-prediction-mode indexes, a second set of the two sets of the combination of the partition-mode index and the two intra-prediction-mode indexes is a combination of a specific partition-mode index and two specific intra-prediction-mode indexes, the specific partition-mode index is set to one partition-mode index associated with another candidate index in a list whose two intra-prediction-mode indexes are equal to the two intra-prediction-mode indexes associated with the single combination-candidate-index component, and two specific intra-prediction-mode indexes are set to the two intra-prediction-mode indexes associated with the single combination-candidate-index component.

37. The method of claim 36, wherein in response to determining there is more than one candidate index in the list whose two intra-prediction-mode indexes are equal to the partition-mode index associated with the single combination-candidate-index component, the specific partition-mode index is set to one partition-mode index associated with one candidate index in the list with the smallest sum of absolute transformed difference (SATD) cost between a prediction and a reconstruction of the template.

38. The method of claim 27, wherein the candidate-index code is associated with a single combination-candidate-index component indicating a first set of the two sets of the combination of the partition-mode index and the two intra-prediction-mode indexes, and a second set of the two sets of the combination of the partition-mode index and the two intra-prediction-mode indexes is a combination of a specific partition-mode index and two specific intra-prediction-mode indexes associated with one candidate index in a list with the smallest sum of absolute transformed difference (SATD) cost between a prediction and a reconstruction of the template.

39. A video decoding system comprising:
a processor; and
a memory coupled to the processor, wherein the processor is configured to execute program instructions stored in the memory to decode a candidate-index code from a bitstream, wherein the candidate-index code is associated with intra-partition prediction and a template comprising one or more index-specified reference lines among a plurality of reference lines having a plurality of reconstructed samples spatially neighboring a block associated with a spatial geometric partitioning mode (SGPM).

40. (canceled)
